(19) United States
(12) Patent Application Publication
(10) Pub. No.: US 2016/0303911 A1
(43) Pub. Date: Oct. 20, 2016

(54) Tire Comprising Carcass Reinforcement Cords Having Low Permeability And Variable Rubber Mixture Thicknesses

(71) Applicants: COMPAGNIE GENERALE DES ETABLISSEMENTS MICHELIN, Clermont-Ferrand (FR); Michelin Recherche et Technique S.A., Granges-Paccot (CH)

(72) Inventors: Benoît BUFFETAUD, Clermont-Ferrand Cedex 9 (FR); Sébastien NOEL, Clermont-Ferrand Cedex 9 (FR); Gilles GODEAU, Clermont-Ferrand Cedex 9 (FR)

(21) Appl. No.: 15/101,606

(22) PCT Filed: Nov. 25, 2014
(86) PCT No.: PCT/EP2014/075544

§ 371 Date: Jun. 3, 2016

(30) Foreign Application Priority Data
Dec. 3, 2013 (FR) 1361987

(51) Int. Cl. B60C 9/08; B60C 13/00; B60C 9/22; B60C 9/00; B60C 1/00; B60C 9/20; B60C 11/00; B60C 15/00

(52) U.S. Cl. CPC B60C 9/08; B60C 11/00; B60C 13/00; B60C 15/00; B60C 9/005; B60C 1/00; B60C 9/0007; B60C 9/20; B60C 9/22; B60C 9/2003; B60C 2009/0416

(57) ABSTRACT

Tire with a radial carcass reinforcement, the tire comprising a crown reinforcement itself capped radially by a tread. The metal reinforcing elements of the carcass reinforcement are non-wrapped cords which, in the test referred to as the permeability test, return a flow rate of less than 20 cm³/min, over at least 50% of the meridian profile of the tire, the thickness of rubber compound between the interior surface of the tire cavity and a point of a metal reinforcing element of the carcass reinforcement being between 1.0 mm and 3.0 mm, the same thickness of rubber compound of two parts of the profile of the tire more or less centered on the orthogonal projection of the shoulder ends of the tire onto the interior surface of the tire being between 2.4 mm and 3.9 mm and the ratio of the thicknesses being greater than 1.10.

The present invention relates to a tire with a radial carcass reinforcement and more particularly to a tire intended for fitting to vehicles carrying heavy loads and travelling on unmade roads such as work site tracks, such as, for example, lorries, tractors or trailers.

In the tires of heavy duty type, the carcass reinforcement is generally anchored on either side in the area of the bead and is surmounted radially by a crown reinforcement made up of at least two layers that are superimposed and formed of threads or cords which are parallel in each layer and crossed from one layer to the next, forming angles of between 10° and 45° with the circumferential direction. The said working layers that form the working reinforcement may be further covered by at least one layer, referred to as a protective layer, formed by reinforcing elements which are advantageously metallic and extensible and referred to as elastic reinforcing elements. It may also comprise a layer of metal threads or cords having low extensibility, forming an angle of between 45° and 90° with the circumferential direction, this ply, called the triangulation ply, being located radially between the carcass reinforcement and the first crown ply, referred to as the working ply, formed by parallel threads or cords lying at angles not exceeding 45° in terms of absolute value. The triangulation ply forms a triangulated reinforcement with at least the said working ply, this reinforcement having low deformation under the various stresses which it undergoes, the triangulation ply essentially serving to absorb the transverse compressive forces acting on all the reinforcing elements in the crown area of the tire.

In the case of tires for “heavy duty” vehicles, just one protective layer is usually present and its protective elements are, in the majority of cases, oriented in the same direction and with the same angle in terms of absolute value as those of the reinforcing elements of the radially outermost and therefore radially adjacent working layer.

The circumferential direction of the tire, or longitudinal direction, is the direction that corresponds to the periphery of the tire and is defined by the direction in which the tire runs.

The transverse or axial direction of the tire is parallel to the axis of rotation of the tire.

The radial direction is a direction intersecting the axis of rotation of the tire and perpendicular thereto.

The axis of rotation of the tire is the axis about which it turns in normal use.

A radial or meridian plane is a plane which contains the axis of rotation of the tire.

The circumferential mid-plane, or equatorial plane, is a plane which is perpendicular to the axis of rotation of the tire and divides the tire into two halves.

Some current tires, referred to as “work site supply” tires are intended to run at relatively modest speeds, over fairly short journeys and over uneven ground. This combination of conditions under which such a tire is called upon to run may lead to significant tread damage although this is combined with a relatively long timewise period of use given the short distances covered; on the other hand, because of the running conditions and the service life, the endurance of the tires is penalized.

The particularly harsh tire running conditions caused by the uneven ground effectively result in there being limits regarding the endurance of these tires.

The elements of the carcass reinforcement are in particular subjected to bending and compressive stresses during running which adversely affect their endurance. Specifically, the cords which form the reinforcing elements of the carcass layers are subjected to high stresses during the running of the tires, in particular to repeated bending actions or variations in curvature, resulting in rubbing actions at the threads and thus in wear, and also in fatigue; this phenomenon is described as “fatigue fretting”.

In order to perform their role of strengthening the carcass reinforcement of the tire, the said cords first of all have to exhibit good flexibility and high flexural endurance, which implies in particular that their threads exhibit a relatively small diameter, preferably less than 0.28 mm, more preferably of less than 0.25 mm, generally smaller than that of the threads used in conventional cords for crown reinforcements of tires.

The cords of the carcass reinforcement are also subject to “fatigue corrosion” phenomena due to the very nature of the cords which favor the passage of and, indeed even drain, corrosive agents such as oxygen and moisture. This is because the air or the water which penetrates into the tire, for example when damaged by a cut or more simply as the result of the permeability, even though low, of the interior surface of the tire, can be conveyed by the channels formed within the cords by the very fact of their structure.

All these fatigue phenomena, which are generally grouped together under the generic term of “fatigue fretting corrosion” cause a progressive deterioration in the mechanical properties of the cords and can, for the most severe running conditions, affect the life of these cords.

In order to improve the endurance of these cords of the carcass reinforcement, it is known in particular to increase the thickness of the layer of rubber which forms the internal wall of the cavity of the tire in order to limit as much as possible the permeability of the said layer. This layer is usually partly composed of butyl, so as to increase the airtightness of the tire. This type of material exhibits the disadvantage of increasing the cost of the tire.

It is also known to modify the construction of the said cords in order in particular to increase their penetrability by the rubber and thus limit the dimension of the passage for the oxidizing agents.

Moreover, the use of tires on heavy duty vehicles of the “work site supply” type, notably when these tires are mounted in tandem on a drive axle or on trailers leads to undesired use in underinflated mode. Specifically, analysis has revealed that tires are often used underinflated without the driver being aware of this. Thus underinflated tires are regularly used. A tire used in this way experiences greater deformation than under normal conditions of use and this may lead to carcass reinforcement cord deformation of the “buckling” type which carries a high penalty notably in terms of ability to withstand the stresses associated with the inflation pressures.

In order to limit this problem associated with the risk of the buckling of the carcass reinforcement reinforcing elements, it is known practice to use cords that are wrapped by an additional thread surrounding the cord and preventing any risk of buckling of the cord or of the threads of which the cord is composed. Tires produced in this way, although less at risk from damage associated with running at low inflation pressures, do have lessened flexural endurance performance notably because of the rubbing between the wrapping thread and the outer threads of the cord as the tire is deformed during running

The inventors thus set themselves the task of providing tires for heavy vehicles for “heavy duty” vehicles of the “work site supply” type, the wear performance of which is retained and the performance, notably endurance performance, of which is improved in particular from the viewpoint of the “fatigue corrosion” or “fatigue fretting corrosion” phenomena, whatever the running conditions, notably in terms of inflation, and of which the manufacturing cost is reduced.

This objective has been achieved according to the invention by a tire with a radial carcass reinforcement, made up of at least one layer of reinforcing elements, the said tire comprising a crown reinforcement, itself capped radially by a tread, the said tread being connected to two beads by two sidewalls, the metal reinforcing elements of at least one layer of the carcass reinforcement being non-wrapped cords which, in the test referred to as the permeability test, return a flow rate of less than 20 cm³/min, and, in a radial plane, over at least 50% of the meridian profile of the tire, the thickness of rubber compound between the interior surface of the tire cavity and the point of a metal reinforcing element of the carcass reinforcement closest to the said interior surface of the cavity being greater than 1.0 mm and less than or equal to 3.0 mm, the thickness of rubber compound between the interior surface of the tire cavity and the point of a metal reinforcing element of the carcass reinforcement closest to the said interior surface of the cavity of two parts of the tire profile which, to within 20 mm, are centered on the orthogonal projection of the shoulder ends of the tire onto the interior surface of the tire being greater than 2.4 mm and less than or equal to 3.9 mm and the ratio between the thicknesses of rubber compound between the interior surface of the tire cavity and the point of a metal reinforcing element of the carcass reinforcement closest to the said interior surface of the cavity of two distinct parts of the tire being greater than 1.10.

Within the meaning of the invention, a shoulder end is defined, in the shoulder region of the tire, by the orthogonal projection onto the exterior surface of the tire of the intersection of the tangents to the surfaces of an axially external end of the tread (top of the tread blocks) on the one hand and of the radially external end of a sidewall on the other.

The test referred to as the permeability test makes it possible to determine the longitudinal permeability to air of the cords tested, by measuring the volume of air passing along a test specimen under constant pressure over a given period of time. The principle of such a test, which is well known to those skilled in the art, is to demonstrate the effectiveness of the treatment of a cord to make it impermeable to air; it has been described for example in standard ASTM D2692-98.

The test is carried out on cords extracted directly, by stripping, from the vulcanized rubber plies which they reinforce, thus penetrated by the cured rubber.

The test is carried out on a 2 cm length of cord, which is therefore coated with its surrounding rubber compound (or coating rubber) in the cured state, in the following way: air is injected into the inlet end of the cord at a pressure of 1 bar and the volume of air at the outlet end is measured using a flow meter (calibrated for example from 0 to 500 cm³/min) During the measurement, the sample of cord is immobilized in a compressed airtight seal (for example, a seal made of dense foam or of rubber) so that only the amount of air passing along the cord from one end to the other, along its longitudinal axis, is taken into account by the measurement; the airtightness of the airtight seal itself is checked beforehand using a solid rubber test specimen, that is to say one devoid of cord.

The lower the mean air flow rate measured (mean over 10 test specimens), the higher the longitudinal impermeability of the cord. As the measurement is carried out with an accuracy of ±0.2 cm³/min, measured values less than or equal to 0.2 cm³/min are regarded as zero; they correspond to a cord which can be described as airtight (completely airtight) along its axis (i.e. in its longitudinal direction).

This permeability test also constitutes a simple means of indirect measurement of the degree of penetration of the cord by a rubber composition. The lower the flow rate measured, the greater the degree of penetration of the cord by the rubber.

The degree of penetration of a cord can also be estimated according to the method described below. In the case of a layered cord, the method consists, in a first step, in removing the outer layer from a sample with a length of between 2 and 4 cm in order to subsequently measure, in a longitudinal direction and along a given axis, the sum of the lengths of rubber compound in relation to the length of the sample. These measurements of lengths of rubber compound exclude the spaces not penetrated along this longitudinal axis. These measurements are repeated along three longitudinal axes distributed over the periphery of the sample and are repeated on five samples of cord.

When the cord comprises several layers, the first step of removal is repeated with what is now the outer layer and the measurements of lengths of rubber compound along longitudinal axes.

A mean of all the ratios of lengths of rubber compound to the lengths of samples thus determined is then calculated in order to define the degree of penetration of the cord.

The thickness of rubber compound between the interior surface of the tire cavity and that point of a reinforcing element that is closest to the said surface is equal to the length of the orthogonal projection onto the interior surface of the tire cavity of the end of that point of a reinforcing element that is closest to the said surface.

The measurements of the thickness of rubber compound are carried out on a cross section of a tire, the tire thus being in a non-inflated state.

According to a preferred embodiment of the invention, the cords of the carcass reinforcement in the test referred to as the permeability test return a flow rate of less than 10 cm³/min and more preferably of less than 2 cm³/min

The inventors have been able to demonstrate that a tire thus produced according to the invention results in highly advantageous improvements in terms of the compromise between endurance and manufacturing costs. Specifically, the endurance properties with such a tire intended for running of the “work site supply” type are at least as good as with the best solutions mentioned hereinabove, whether under normal running conditions or even under underinflated running conditions. Moreover, since the thickness of the layer of rubber compound between the carcass reinforcement and the cavity of the tire is at least locally reduced in comparison with conventional tires and because this layer is one of the most expensive components of the tire, the cost of manufacture of the tire is lower than that of a conventional tire.

The carcass reinforcement cords which, in the test referred to as the permeability test, return a flow rate of less than 20 cm³/min make it possible on the one hand to limit the risk associated with corrosion and, on the other hand, appear to have an effect that counters the buckling of the cords thus making it possible to reduce the thickness of rubber compounds between the interior surface of the cavity of the tire and the carcass reinforcement.

The inventors have also been able to demonstrate that increasing the thickness of the layer of rubber compound between the carcass reinforcement and the cavity of the tire over two parts of the meridian profile of the tire is necessary in order to limit the radii of curvature of the carcass reinforcement reinforcing elements when running under inflated because of the extreme stress experienced by the tires on uneven and notably rocky ground, thus contributing to combatting the buckling of the cords. Specifically, the inventors have been able to demonstrate that the local increase in thicknesses of rubber compound is made not to limit the risk of cord corrosion as described previously but to perform a “mechanical” role making it possible to limit the appearance of excessively small radii of curvature at the carcass reinforcement reinforcing elements and, in combination with the choice of carcass reinforcement cords which, in the test referred to as the permeability test, return a flow rate of less than 20 cm³/min, prevent the phenomena of cord buckling. Excessively small radii of curvature attained by the reinforcing elements of the carcass reinforcement are in fact detrimental to the endurance performance of the cords and therefore of the carcass reinforcement.

The inventors have thus been able to find a compromise between the cost of manufacture of the tire and the endurance performance thereof, while at the same time maintaining satisfactory tire wear properties. The local increase in the thicknesses of rubber compound contributes to an increase in cost, modest because of the nature of the compound, but which when combined with the choice of carcass reinforcement cords which, in the test referred to as the permeability test, return a flow rate of less than 20 cm³/min, ensures that endurance performance is satisfactory despite the “work site supply” conditions under which these tires are used.

According to one preferred embodiment of the invention, in a radial plane, the thickness of rubber compound between the interior surface of the cavity of the tire and the point of a metal reinforcing element of the carcass reinforcement closest to the said interior surface of the cavity is greater than 1.0 mm and less than or equal to 3.0 mm over at least 60% of the meridian profile of the tire.

Advantageously according to the invention, in a radial plane, the ratio between thicknesses of rubber compound between the interior surface of the cavity of the tire and the point of a metal reinforcing element of the carcass reinforcement closest to the said interior surface of the cavity of two distinct parts of the tire is greater than or equal to 1.15 and preferably greater than or equal to 1.18.

For preference also according to the invention, the meridian length of a part of the tire which, to within 20 mm, is centered on the orthogonal projection of the shoulder ends of the tire onto the interior surface of the tire, of which the thickness of rubber compound between the interior surface of the cavity of the tire and the point of a metal reinforcing element of the carcass reinforcement closest to the said interior surface of the cavity is greater than 2.4 mm and less than or equal to 3.9 mm, is between 60 and 200 mm

According to one preferred embodiment of the invention, with the rubber compound between the cavity of the tire and the reinforcing elements of the radially innermost layer of carcass reinforcement made up of at least two layers of rubber compound, at the parts of the meridian profile of the tire that have a thickness of rubber compound between the interior surface of the cavity of the tire and the point of a metal reinforcing element of the carcass reinforcement closest to the said interior surface of the cavity greater than 1.0 mm and less than or equal to 3.0 mm, the radially innermost layer of rubber compound that forms the interior surface of the cavity of the tire has a thickness of less than 1.4 mm and preferably less than 1.2 mm As explained previously, this layer is usually composed in part of butyl so as to increase the airtightness of the tire and because this type of material has a not insignificant cost, reducing the thickness of this layer is beneficial.

Preferably too according to the invention, at the parts of the meridian profile of the tire that have a thickness of rubber compound between the interior surface of the cavity of the tire and the point of a metal reinforcing element of the carcass reinforcement closest to the said interior surface of the cavity greater than 1.0 mm and less than or equal to 3.0 mm, the layer of rubber compound radially adjacent to the radially innermost layer of rubber compound has a thickness of less than 1.4 mm and preferably less than 1.2 mm The thickness of this layer, the constituents of which notably allow oxygen from the air to be fixed, may also be reduced so as to further reduce the cost of the tire.

The thicknesses of each of these two layers are equal to the length of the orthogonal projection of a point of one surface onto the other surface of the said layer.

Advantageously according to the invention, the overthickness of rubber compound of the two parts of the profile of the tire which, to within 20 mm, are centered on the orthogonal projection of the shoulder ends of the tire onto the interior surface of the tire, with respect to the other regions of the tire is obtained by adding a rubber compound radially on the inside of the layer of compound that makes the tire cavity airtight. Indeed the inventors have been able to demonstrate that it was preferable not to increase the thickness of the compound that provides the airtightness given that this compound is very expensive and that the desired function of these overthicknesses is of a “mechanical” nature.

Advantageously too, this overthickness can be achieved with a rubber compound identical to that of the layer of rubber compound radially adjacent to and on the inside of the layer of rubber compound that provides the airtightness. Specifically, this compound, the constituents of which notably allow the fixing of oxygen from the air, may, in addition to performing its “mechanical” role, afford additional protection against potential risks of oxidation.

These overthicknesses can be obtained in various ways while the tire is being manufactured. A first method involves creating the layer of rubber compound that forms the wall of the tire cavity with the desired profile to form these overthicknesses with the two desired compounds, these compounds being coextruded. Another method consists in creating these two regions of overthickness by adding additional layers of rubber compounds locally.

According to one advantageous embodiment of the invention, the metal reinforcing elements of at least one layer of the carcass reinforcement are cords having at least two layers, at least an inner layer being sheathed with a layer consisting of a crosslinkable or crosslinked rubber composition, preferably based on at least one diene elastomer.

The invention also proposes a tire with a radial carcass reinforcement, made up of at least one layer of reinforcing elements, the said tire comprising a crown reinforcement, itself capped radially by a tread, the said tread being connected to two beads by two sidewalls, the metal reinforcing elements of at least one layer of the carcass reinforcement being non-wrapped cords having at least two layers, at least an inner layer being sheathed with a layer consisting of a crosslinkable or crosslinked rubber composition, preferably based on at least one diene elastomer and in a radial plane, at least over part of the meridian profile of the tire, in a radial plane, over at least 50% of the meridian profile of the tire, the thickness of rubber compound between the interior surface of the cavity of the tire and the point of a metal reinforcing element of the carcass reinforcement closest to the said interior surface of the cavity being greater than 1.0 mm and less than or equal to 3.0 mm, the thickness of rubber compound between the interior surface of the cavity of the tire and the point of a metal reinforcing element of the carcass reinforcement closest to the said interior surface of the cavity of two parts of the profile of the tire which, to within 20 mm, are centered on the orthogonal projection of the shoulder ends of the tire onto the interior surface of the tire being greater than 2.4 mm and less than or equal to 3.9 mm and the ratio between thicknesses of rubber compound between the interior surface of the cavity of the tire and the point of a metal reinforcing element of the carcass reinforcement closest to the said interior surface of the cavity of two distinct parts of the tire being greater than 1.15.

Within the meaning of the invention, cords, having at least two layers, at least one inner layer being sheathed with a layer consisting of a polymer composition, return, in the test referred to as the permeability test, a flow rate of less than 20 cm³/min and advantageously of less than 2 cm³/min.

The expression “composition based on at least one diene elastomer” is understood to mean, in a known way, that the composition predominantly comprises (i.e. in a fraction of more than 50% by weight) this or these diene elastomers.

It should be noted that the sheath according to the invention extends continuously around the layer that it covers (that is to say that this sheath is continuous in the “orthoradial” direction of the cord which is perpendicular to its radius), so as to form a continuous sleeve having a cross section which is advantageously practically circular.

It will also be noted that the rubber composition of this sheath is crosslinkable or crosslinked; in other words that it comprises, by definition, a crosslinking system adapted to allow the composition to be crosslinked in the course of its curing (i.e. allowing it to harden, not melt); thus, this rubber composition may be described as non-meltable because it cannot be melted by heating, regardless of the temperature.

The term “diene” elastomer or rubber is understood to mean, in a known way, an elastomer which is based, at least partially (i.e. is a homopolymer or a copolymer), on diene monomers (monomers bearing two conjugated or non-conjugated carbon-carbon double bonds).

Preferably, the system for crosslinking the rubber sheath is what is referred to as a vulcanization system, i.e. one based on sulphur (or on a sulphur donor) and a primary vulcanization accelerator. This basic vulcanization system may be supplemented with various known secondary accelerators or vulcanization activators.

The rubber composition of the sheath according to the invention comprises, in addition to the said crosslinking system, all the customary ingredients that can be used in rubber compositions for tires, such as reinforcing fillers based on carbon black and/or on an inorganic reinforcing filler such as silica, anti-ageing agents, for example antioxidants, extension oils, plasticizers or agents facilitating the workability of the compositions in the raw state, methylene acceptors and donors, resins, bismaleimides, known adhesion promoter systems of the RFS (resorcinol formaldehyde silica) type, or metal salts, notably cobalt salts.

Preferably, the composition of this sheath is chosen to be identical to the composition used for the rubber matrix which the cords according to the invention are intended to reinforce. Thus, there is no problem of possible incompatibility between the respective materials of the sheath and of the rubber matrix.

According to one alternative form of the invention, the metal reinforcing elements of at least one layer of the carcass reinforcement are layered metal cords of [L+M] or [L+M+N] construction that can be used as reinforcing elements in a tire carcass reinforcement, comprising a first layer C1 of L threads of diameter d₁, with L ranging from 1 to 4, surrounded by at least one intermediate layer C2 of M threads of diameter d₂ wound together in a helix at a pitch p₂ with M ranging from 3 to 12, the said layer C2 possibly being surrounded by an outer layer C3 of N threads of diameter d₃ wound together in a helix at a pitch p₃ with N ranging from 8 to 20, a sheath made of a crosslinkable or crosslinked rubber composition based on at least one diene elastomer covering the said first layer C1 in the [L+M] construction and at least the said layer C2 in the [L+M+N] construction.

Preferably, the diameter of the threads of the first layer of the inner layer (C1) is between 0.10 and 0 5 mm and the diameter of the threads of the external layers (C2, C3) is between 0.10 and 0.5 mm

Also preferably, the helical pitch at which the said threads of the external layer (C3) are wound is between 8 and 25 mm

Within the meaning of the invention, the pitch represents the length, measured parallel to the axis of the cord, at the end of which a thread having this pitch completes a full turn around the axis of the cord; thus, if the axis is sectioned by two planes perpendicular to the said axis and separated by a length equal to the pitch of a thread of a layer forming the cord, the axis of this thread has, in these two planes, the same position on the two circles corresponding to the layer of the thread in question.

Advantageously, the cord has one, or even more preferably, all, of the following characteristics:
the layer C3 is a saturated layer, that is to say that there is not enough space in this layer to add thereto at least one (N+1)th thread of diameter d₃, N then representing the maximum number of threads that can be wound in a layer around the layer C2;
the rubber sheath also covers the inner layer C1 and/or separates the adjacent pairs of threads of the intermediate layer C2;
the rubber sheath practically covers half the radially inner circumference of each thread of the layer C3, such that it separates the adjacent pairs of threads of this layer C3.

Preferably, the rubber sheath has a mean thickness ranging from 0.010 mm to 0.040 mm

Generally, the invention can be implemented, in order to form the above-described cords of the carcass reinforcement, with any type of metal threads, in particular made of steel, for example threads made of carbon steel and/or threads made of stainless steel. A carbon steel is preferably used, but it is, of course, possible to use other steels or other alloys.

Where a carbon steel is used, its carbon content (% by weight of steel) is preferably comprised between 0.1% and 1.2%, more preferably from 0.4% to 1.0%; these contents represent a good compromise between the mechanical properties required for the tire and the workability of the thread. It should be noted that a carbon content of between 0.5% and 0.6% ultimately make such steels less expensive as they are easier to draw.

Another advantageous embodiment of the invention may also consist, depending on the intended applications, in using steels with a low carbon content, for example between 0.2% and 0.5%, notably on account of a lower cost and greater ease of drawing.

The cord according to the invention may be obtained by various techniques known to a person skilled in the art, for example in two steps, initially by sheathing the core or intermediate L+M structure (layers C1+C2) via an extrusion head, this step being followed, in a second step, by a final operation in which the remaining N threads (layer C3) are cabled or twisted around the layer C2 thus sheathed. The problem of tackiness in the raw state posed by the rubber sheath during any intermediate operations of winding and unwinding may be overcome in a manner known to those skilled in the art, for example by using an interlayer film of plastics material.

According to an alternative form of embodiment of the invention, the crown reinforcement of the tire is formed of at least two working crown layers of inextensible reinforcing elements, crossed from one layer to the other, forming, with the circumferential direction, angles of between 10° and 45°.

According to other alternative forms of embodiment of the invention, the crown reinforcement further comprises at least one layer of circumferential reinforcing elements.

One preferred embodiment of the invention also plans for the crown reinforcement to be supplemented radially on the outside by at least one additional layer, referred to as a protective layer, of reinforcing elements, referred to as elastic reinforcing elements, oriented with respect to the circumferential direction at an angle of between 10° and 45° and in the same direction as the angle formed by the inextensible elements of the working layer radially adjacent to it.

The protective layer may have an axial width less than the axial width of the least wide working layer. The said protective layer may also have an axial width greater than the axial width of the least wide working layer, such that it covers the edges of the least wide working layer and, if the radially uppermost layer is the least wide layer, such that it is coupled, in the axial extension of the additional reinforcement, to the widest working crown layer over an axial width and is then decoupled, axially on the outside, from the said widest working layer by profiled elements with a thickness of at least 2 mm In the aforementioned case, the protective layer formed of elastic reinforcing elements may, on the one hand, be decoupled if required from the edges of the said least wide working layer by profiled elements with a thickness substantially less than the thickness of the profiled elements separating the edges of the two working layers, and, on the other hand, have an axial width less than or greater than the axial width of the widest crown layer.

According to any one of the embodiments of the invention mentioned hereinabove, the crown reinforcement may be further supplemented, radially on the inside between the carcass reinforcement and the radially interior working layer closest to the said carcass reinforcement, by a triangulation layer made of metal inextensible reinforcing elements made of steel and forming, with the circumferential direction, an angle of more than 60° and the same direction as the angle formed by the reinforcing elements of the radially closest layer of the carcass reinforcement.

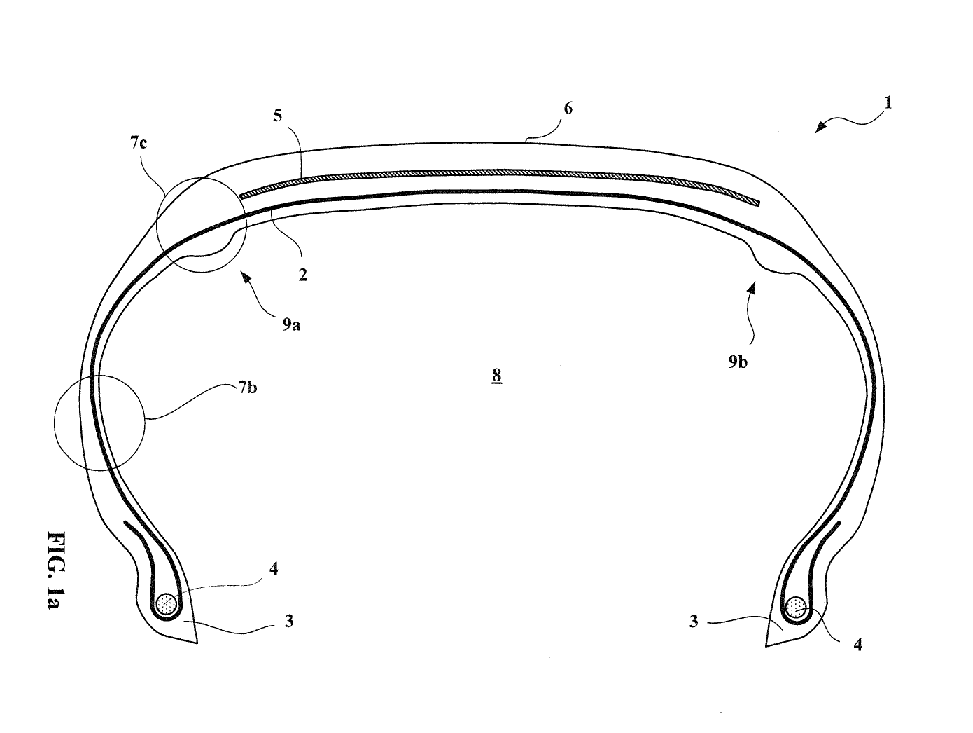

Further details and advantageous features of the invention will become apparent hereinafter from the description of the exemplary embodiments of the invention, with reference to FIGS. 1 to 5 in which:

FIG. 1a is a schematic meridian view of a tire according to one embodiment of the invention,

FIG. 1b is an enlarged partial view of a part of the schematic view of FIG. 1a,

FIG. 1c is an enlarged partial view of another part of the schematic view of FIG. 1a,

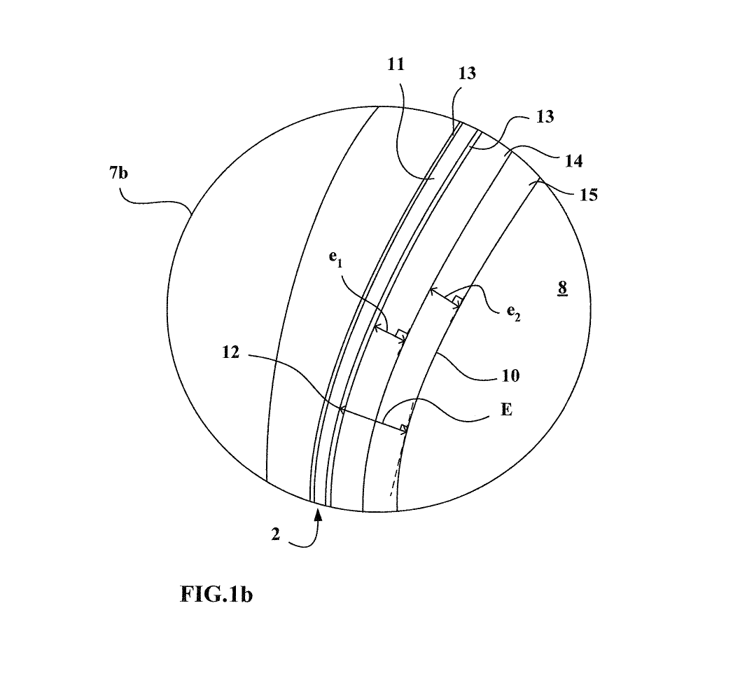

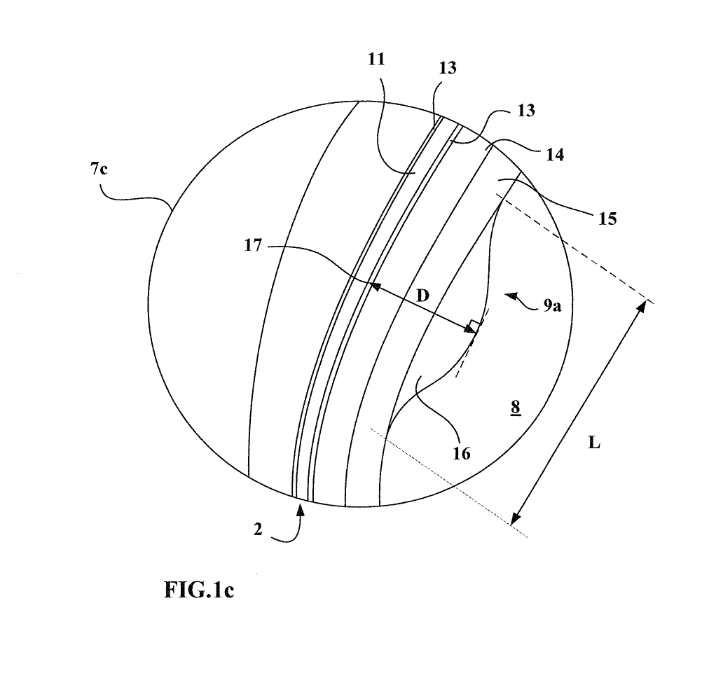

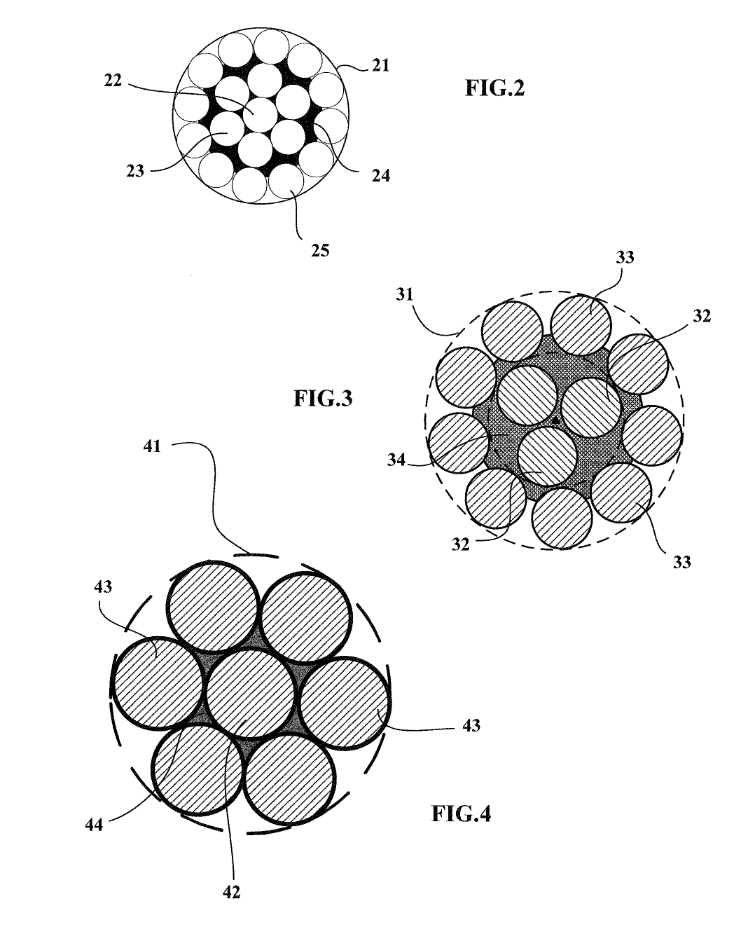

FIG. 2 is a schematic view in cross section of a carcass reinforcement cord of the tire of FIG. 1,

FIG. 3 is a schematic view in cross section of a first other example of a carcass reinforcement cord according to the invention,

FIG. 4 is a schematic view in cross section of a second other example of a carcass reinforcement cord according to the invention,

FIG. 5 is a schematic view in cross section of a tyre showing how to determine a shoulder end.

In order to make them easier to understand, the figures are not shown to scale.

In FIG. 1a, the tire 1, of size 315/80 R 22.5 Y, comprises a radial carcass reinforcement 2 anchored in two beads 3 around bead wires 4. The carcass reinforcement 2 is formed of a single layer of metal cords 11 and of two calendering layers 13. The carcass reinforcement 2 is hooped by a crown reinforcement 5, itself capped by a tread 6. The crown reinforcement 5 is formed radially, from the inside towards the outside:
of a triangulation layer formed of non-wrapped inextensible 9.28 metal cords which are continuous across the entire width of the ply and oriented at an angle equal to 65°,
of a first working layer formed of non-wrapped inextensible 11.35 metal cords which are continuous across the entire width of the ply, oriented at an angle of 26°,
of a second working layer formed of non-wrapped inextensible 11.35 metal cords which are continuous across the entire width of the ply, oriented at an angle of 18° and crossed with the metal cords of the first working layer,
of a protective layer formed of elastic 18.23 metal cords.

This combination of layers constituting the crown reinforcement 5 is not depicted in detail in the figures.

The interior surface 10 delimiting the cavity of the tire has irregularities such as shapes like bosses which according to the invention correspond to parts 9a and 9b having a thickness between the interior surface 10 and the carcass reinforcement 2 that is greater than over the rest of the meridian profile of the tire. The parts 9a and 9b are, according to the invention, the two parts of the tire profile which, to within 20 mm, are centered on the orthogonal projection 51 of the shoulder ends 52 of the tire onto the interior surface 10 of the tire.

FIG. 5 represents a meridian view of a diagram of a tire 1 on which a first tangent 53 to the surface of an axially outer end of the tread 6; the surface of the tread 6 is defined by the radially outer surface or crown of the tread patterns, which are not shown in the figures. A second tangent 54 to the surface of the radially outer end of a sidewall 55 intersects the first tangent 53 at a point 56. The orthogonal projection of this point 56 to the outer surface of the tire defines the shoulder end 52. On FIG. 5 is also shown the orthogonal projection 51 of shoulder ends 52 of the tire onto the interior surface 10 of the tire.

The axial width L of the tread can also be measured between the two shoulder ends 52.

FIG. 1b is an enlargement of region 7b of FIG. 1a and notably indicates the thickness E of rubber compound between the interior surface 10 of the cavity 8 of the tire and the point 12 of a reinforcing element 11 closest to the said surface 10. This thickness E is equal to the length of the orthogonal projection onto the surface 10 of the point 12 of a reinforcing element 11 that is closest to the said surface 10. This thickness E is the sum of the thicknesses of the various rubber compounds placed between the said reinforcing element 11 of the carcass reinforcement 2; it corresponds, on the one hand, to the thickness of the calendering layer 13 radially on the inside of the carcass reinforcement and, on the other hand, to the thicknesses e₁, e₂ of the various layers 14, 15 of rubber compound that form the internal wall of the tire 1. These thicknesses e₁, e₂ are moreover equal to the length of the orthogonal projection of a point on one surface onto the other surface of the respective layer 14 or 15 concerned.

These thickness measurements are carried out on a cross section of the tire, the latter consequently not being fitted or inflated.

The value E measured is equal to 2.6 mm.

The values of e₁ and e₂ are respectively equal to 1.2 mm and 1.2 mm.

FIG. 1c illustrates an enlargement of the region 7c of FIG. 1a and notably indicates the thickness D of rubber compound between the interior surface 10 of the cavity 8 of the tire and the point 17 of a reinforcing element 11 closest to the said surface 10 in the region of the part 9a. This thickness D is equal to the length of the orthogonal projection onto the surface 10 of the point 17 of a reinforcing element 11 that is closest to the said surface 10 at the location of the greatest thickness at the part 9a. This thickness D is the sum of the thicknesses of the various rubber compounds placed between the said reinforcing element 11 of the carcass reinforcement 2; it corresponds, on the one hand, to the thickness of the calendering layer 13 radially on the inside of the carcass reinforcement and, on the other hand, to the respective thicknesses of the various layers 14, 15, 16 of rubber compound that form the internal wall of the tire 1.

The layer 15 is, as described hereinabove, made up partially of butyl so as to increase the airtightness of the tire. The layer 14 advantageously contains constituents that notably allow oxygen in the air to be fixed. The reduction in the thicknesses of these two layers is beneficial to reducing the cost of the tire as the materials of which these layers are made have costs that are not insignificant. The layer 16 provided locally on the meridian profile of the tire in the part 9a is advantageously similar in terms of composition to the layer 14 so that it can enhance the oxygen-fixing function in addition to performing its aforementioned “mechanical” function. The parts 9a and 9b concerned correspond to the shoulders of the tire.

The thickness D at the part 9a is equal to 3.1 mm and therefore comprised between 2.4 and 3.9 mm.

The ratio of the thicknesses D to E is equal to 1.19 and thus greater than 1.15.

The length L corresponding to the meridian length of the overthickness of the part 9a is equal to 156 mm and therefore comprised between 60 and 200 mm The sum of the lengths of the overthicknesses of the four parts 9a and 9b is equal to 312 mm and corresponds to 46% of the length of the meridian profile of the wall 10 of the tire 1.

FIG. 1c illustrates an additional layer 16 comprising constituents notably allowing the fixing of the oxygen from the air added locally in the region of the cavity of the tire. The nature of the layer 16 could, according to other alternative forms of embodiment of the invention, be different. Furthermore, the local overthicknesses could even be obtained for example by locally modifying the respective thicknesses of one and/or other of the layers 14 and 15 or alternatively by locally interposing one or more layers between the layers 14 and 15 or alternatively still between the carcass reinforcement 2 and the layer 14.

Local increases in the thickness between the interior surface 10 and the carcass reinforcement 2 are a step in the opposite direction to reducing the cost of the tire but do lead to a satisfactory endurance/cost compromise.

FIG. 2 is a schematic depiction of the cross section of a carcass reinforcement cord 21 of the tire 1 of FIG. 1. This cord 21 is a non-wrapped layered cord of 1+6+12 structure, composed of a central nucleus formed of a thread 22, of an intermediate layer formed of six threads 23 and of an outer layer formed of twelve threads 25.

It exhibits the following characteristics (d and p in mm):
1+6+12 structure;
d₁=0.20 (mm);
d₂=0.18 (mm);
p₁=10 (mm);
d₃=0.18 (mm);
p₂=10 (mm);
(d₂/d₃)=1;
   with d₂ and p₂ respectively the diameter and the helical pitch of the intermediate layer and d₃ and p₃ respectively the diameter and the helical pitch of the threads of the outer layer.

The core of the cord, composed of the central nucleus formed of the thread 22 and of the intermediate layer formed of the six threads 23 is sheathed with a rubber composition 24 based on non vulcanized elastomer (in the raw state). The sheathing is obtained via a head for extrusion of the core composed of the thread 22 surrounded by the six threads 23, followed by a final operation in which the 12 threads 25 are twisted or cabled around the core thus sheathed.

The aptitude for penetration of the cord 31, measured according to the method described above, is equal to 95%.

The elastomeric composition constituting the rubber sheath 24 is produced from the composition as described above and exhibits, in the present case, the same formulation, based on natural rubber and on carbon black, as that of the calendering layers 13 of the carcass reinforcement which the cords are intended to reinforce.

FIG. 3 is a schematic depiction of the cross section of another carcass reinforcement cord 31 which can be used in a tire according to the invention. This cord 31 is a non-wrapped layered cord of 3+9 structure, composed of a central core formed of a cord composed of three threads 32 twisted together and of an outer layer formed of nine threads 33.

It exhibits the following characteristics (d and p in mm):
3+9 structure;
d₁=0.18 (mm);
p₂=5 (mm);
(d₁/d₂)=1;
d₂=0.18 (mm);
p₃=10 (mm);
   with d₁ and p₁ respectively being the diameter and the helical pitch of the threads of the central core and d₂ and p₂ respectively being the diameter and the helical pitch of the threads of the outer layer.

The central core composed of a cord formed of the three threads 32 was sheathed with a rubber composition 34 based on non-vulcanized diene elastomer (in the raw state). The sheathing is obtained via a head for extrusion of the cord 32, followed by a final operation in which the 9 threads 33 are cabled around the core thus sheathed.

The aptitude for penetration of the cord 31, measured according to the method described hereinabove, is equal to 95%.

FIG. 4 is a schematic depiction of the cross section of another carcass reinforcement cord 41 which can be used in a tire according to the invention. This cord 41 is a non-wrapped layered cord of 1+6 structure, composed of a central nucleus formed of a thread 42 and of an outer layer formed of six threads 43.

It exhibits the following characteristics (d and p in mm):
1+6 structure;
d₁=0.200 (mm);
(d₁/d₂)=1.14;
d₂=0.175 (mm);
p₂=10 (mm);
   with d₁ the diameter of the nucleus and d₂ and p₂ respectively the diameter and the helical pitch of the threads of the outer layer.

The central nucleus composed of the thread 42 was sheathed with a rubber composition 44 based on non-vulcanized diene elastomer (in the raw state). The sheathing is obtained via a head for extrusion of the thread 42, followed by a final operation in which the 6 threads 43 are cabled around the nucleus thus sheathed.

The aptitude for penetration of the cord 41, measured according to method described hereinabove, is equal to 95%.

Tests have been carried out on tires produced according to the invention in accordance with the depiction of FIGS. 1 and 2, and other tests have been carried out with what are referred to as reference tires.

These reference tires differ from the tires according to the invention through carcass reinforcement cords that do not have the sheathing layer 24 and by the fact that the thickness E of rubber compound between the interior surface of the cavity of the tire and the point of a reinforcing element closest to the said surface is equal to 3.9 mm, each of the thicknesses e₁ and e₂ being respectively equal to 1.7 mm and 2.0 mm across the entire meridian profile of the tire.

Endurance testing with running on a drive axle of a vehicle were carried out, with the tires being subjected to a load of 3680 daN and a speed of 40 km/h, with the tires inflated to 0.2 bar. The tests were carried out on tires according to the invention under conditions identical to those applied to the reference tires. The running operations are halted as soon as the tires exhibit carcass reinforcement degradation.

The tests thus carried out demonstrated that the distances covered during each of these tests with the tires according to the invention made it possible to achieve distances covered that are similar to those covered by the reference tires.

Furthermore, the cost of manufacture of the tires according to the invention is not as high, being 3% lower in the case of the tires according to the invention as compared with that of the reference tires.

Moreover, the tires according to the invention offer the advantage of being less heavy, with a 3% lightening of weight in comparison with the reference tires.

1. A tire with a radial carcass reinforcement, made up of at least one layer of metal reinforcing elements, the said tire comprising a crown reinforcement, capped radially by a tread, said tread being connected to two beads by two sidewalls, wherein the metal reinforcing elements of at least one layer of the carcass reinforcement are non-wrapped cords which, in the test referred to as the permeability test, return a flow rate of less than 20 cm³/min, wherein, in a radial plane, over at least 50% of the meridian profile of the tire, the thickness of rubber compound between the interior surface of the tire cavity and the point of a metal reinforcing element of the carcass reinforcement closest to said interior surface of the cavity is greater than 1.0 mm and less than or equal to 3.0 mm, wherein the thickness of rubber compound between the interior surface of the tire cavity and the point of a metal reinforcing element of the carcass reinforcement closest to the said interior surface of the cavity of two parts of the tire profile which, to within 20 mm, are centered on the orthogonal projection of the shoulder ends of the tire onto the interior surface of the tire is greater than 2.4 mm and less than or equal to 3.9 mm, and wherein the ratio between thicknesses of rubber compound between the interior surface of the tire cavity and the point of a metal reinforcing element of the carcass reinforcement closest to said interior surface of the cavity of two distinct parts of the tire is greater than 1.10.

2. Tiro The tire according to claim 1, wherein the metal reinforcing elements of at least one layer of the carcass reinforcement are cords having at least two layers and wherein at least an inner layer is sheathed with a layer consisting of a crosslinkable or crosslinked rubber composition.

3. The tire according to claim 1, wherein the cords in the test referred to as the permeability test return a flow rate of less than 10 cm³/min.

4. A tire with a radial carcass reinforcement, made up of at least one layer of reinforcing elements, the tire comprising a crown reinforcement capped radially by a tread, said tread being connected to two beads by two sidewalls, wherein the metal reinforcing elements of at least one layer of the carcass reinforcement are non-wrapped cords having at least two layers, at least an inner layer being sheathed with a layer consisting of a crosslinkable or crosslinked rubber composition, in that wherein, in a radial plane, over at least 50% of the meridian profile of the tire, the thickness of rubber compound between the interior surface of the cavity of the tire and the point of a metal reinforcing element of the carcass reinforcement closest to said interior surface of the cavity is greater than 1.0 mm and less than or equal to 3.0 mm, wherein the thickness of rubber compound between the interior surface of the cavity of the tire and the point of a metal reinforcing element of the carcass reinforcement closest to said interior surface of the cavity of two parts of the profile of the tire which, to within 20 mm, are centered on the orthogonal projection of the shoulder ends of the tire onto the interior surface of the tire is greater than 2.4 mm and less than or equal to 3.9 mm, and wherein the ratio between thicknesses of rubber compound between the interior surface of the cavity of the tire and the point of a metal reinforcing element of the carcass reinforcement closest to said interior surface of the cavity of two distinct parts of the tire is greater than 1.10.

5. The tire according to claim 1 or 4, wherein, in a radial plane, the ratio between thicknesses of rubber compound between the interior surface of the cavity of the tire and the point of a metal reinforcing element of the carcass reinforcement closest to said interior surface of the cavity of two distinct parts of the tire is greater than or equal to 1.15.

6. The tire according to claim 1 or 4, wherein, in a radial plane, over at least the part of the meridian profile of the tire over which the thickness of rubber compound between the interior surface of the cavity of the tire and the point of a metal reinforcing element of the carcass reinforcement closest to said interior surface of the cavity is greater than 1.0 mm and less than or equal to 3.0 mm, thickness of rubber compound forming the interior surface of the cavity of the tire is less than or equal to 1.4 mm.

7. The tire according to claim 1 or 4, wherein the meridian length of the two parts of the profile of the tire which, to within 20 mm, are centered on the orthogonal projection of the shoulder ends of the tire onto the interior surface of the tire of which the thickness of rubber compound between the interior surface of the cavity of the tire and the point of a metal reinforcing element of the carcass reinforcement closest to said interior surface of the cavity is greater than 2.4 mm and less than or equal to 3.9 mm is between 60 and 200 mm.

8. The tire according to claim 1 or 4, wherein the metal reinforcing elements of at least one layer of the carcass reinforcement are layered metal cords of [L+M] or [L+M+N] construction that can be used as reinforcing elements in a tire carcass reinforcement, comprising a first layer C1 of L threads of diameter d₁, with L ranging from 1 to 4, surrounded by at least one intermediate layer C2 of M threads of diameter d₂ wound together in a helix at a pitch p₂ with M ranging from 3 to 12, said layer C2being surrounded by an outer layer C3 of N threads of diameter d₃ wound together in a helix at a pitch p₃ with N ranging from 8 to 20, and wherein a sheath made of a crosslinkable or crosslinked rubber composition based on at least one diene elastomer covers said first layer C1 in the [L+M] construction and at least said layer C2 in the [L+M+N] construction.

9. The tire according to claim 8, wherein the diameter of the threads of the first layer is between 0.10 and 0.5 mm, and wherein the diameter of the threads of the layers is between 0.10 and 0.5 mm.

10. The tire according to claim 1 or 4, wherein the crown reinforcement is formed of at least two working crown layers of inextensible reinforcing elements, crossed from one layer to the other, forming, with the circumferential direction, angles of between 10° and 45°.

11. Tiro The tire according to claim 1 or 4, wherein the crown reinforcement further comprises at least one layer of circumferential reinforcing elements.

12. The tire according to claim 1 or 4, wherein the crown reinforcement is supplemented radially on the outside by at least one additional ply, referred to as a protective ply, of reinforcing elements, referred to as elastic reinforcing elements, oriented with respect to the circumferential direction at an angle of between 10° and 45° and in the same direction as the angle formed by the inextensible elements of the working ply radially adjacent to it.

13. The tire according to claim 1 or 4, wherein the crown reinforcement further includes a triangulation layer formed of metal reinforcing elements forming with the circumferential direction angles of more than 60° .
